(19) United States
(12) Patent Application Publication
(10) Pub. No.: US 2011/0169728 A1
(43) Pub. Date: Jul. 14, 2011

(54) ROTATABLE DISPLAY DEVICE AND IMAGE DISPLAYING METHOD THEREOF

(75) Inventor: Chao-Wei Huang, Taipei Hsien (TW)

(73) Assignee: ACER INCORPORATED, Taipei Hsien (TW)

(21) Appl. No.: 12/832,076

(22) Filed: Jul. 8, 2010

(30) Foreign Application Priority Data
Jan. 14, 2010 (TW) 99100966

(51) Int. Cl. G09G 5/00

(52) U.S. Cl. 345/156; 345/698

(57) ABSTRACT

A rotatable display device and an image displaying method thereof are provided. In the present method, a plurality of display signal formats is defined in the rotatable display device, wherein each of the display signal formats corresponds to a display direction of the rotatable display device. Then, one of the display signal formats is provided to a host according to the display direction of the rotatable display device. Finally, the rotatable display device displays an image signal which is directly outputted according to the display signal format received by the host.

### CROSS-REFERENCE TO RELATED APPLICATION

This application claims the priority benefit of Taiwan application serial no. 99100966, filed on Jan. 14, 2010. The entirety of the above-mentioned patent application is hereby incorporated by reference herein and made a part of this specification.

### BACKGROUND OF THE INVENTION

1. Field of the Invention

The invention is directed to an image displaying method, and more particularly to an image displaying method adopted in a rotatable display device and relevant applications thereof.

2. Description of Related Art

Generally, the extended display identification data (EDID) containing information such as the maximum resolution and scanning frequency supported by the screen, the name and serial number of the manufacturer, and so on is recorded in the screen. When the screen is connected to the computer host, the display card within the computer host is capable of reading the EDID recorded in the screen through the inter-integrated circuit (I2C) bus, so as to adjust the signal to be outputted to the screen correspondingly.

Currently, some screen products in the market are capable of supporting rotational display, so the user can select between horizontal mode and vertical mode to display the current viewing page suitably. Take a screen with 1920×1080 resolution as an example, the display card transmits the image signal of this resolution to the screen when being connected with the computer host. However, when the user rotates the screen 90°, the display card still identifies the computer host as being connected to the screen with 1920×1080 resolution according to the EDID transmitted to the computer host, such that the image signal is outputted according to this resolution. As a consequence, the user is unable of reading the content displayed on the screen.

In order to solve the foregoing issue, a software tool is usually provided by the display card. Thus, when the user rotates the screen, the software tool notifies the display card to adjust the image signal to be outputted according to the resolution adapted after screen rotation. Accordingly, the image content is displayed correctly on the rotated screen by changing the signal source. Nevertheless, most of the users may not know how to initiate the software tool provided by the display card or may be unaware of this adjusting function, such that the application of rotational display is not popularized.

### SUMMARY OF THE INVENTION

The invention is directed to an image displaying method for a host to output a correct image signal automatically when a user rotates a rotatable display device into a different display direction.

The invention is directed to a rotatable display device which is capable of correctly displaying the image in different display directions without any manual settings by the user.

The invention is directed to an image displaying method adopted in a rotatable display device. The image displaying method defines a plurality of display signal formats in the rotatable display device, where each of the display signal formats corresponds to a display direction of the rotatable display device respectively. The image displaying method provides one of the display signal formats to a host according to the display direction of the rotatable display device. The rotatable display device displays an image signal outputted according to the display signal format received by the host.

In one embodiment of the invention, the step of providing one of the display signal formats to the host according to the display direction of the rotatable display device includes detecting the display direction of the rotatable display device, selecting the display signal format corresponding to the display direction from all of the display signal formats, and providing the selected display signal format to the host.

In one embodiment of the invention, the step of providing one of the display signal formats to the host according to the display direction of the rotatable display device further includes disconnecting and re-establishing the connection between the rotatable display device and the host when the display direction is changed.

In one embodiment of the invention, the step of disconnecting and re-establishing the connection between the rotatable display device and the host includes re-initiating the power of the rotatable display device.

In one embodiment of the invention, each of the display signal formats comprises a resolution and a scanning frequency consistent with the corresponding display direction.

In one embodiment of the invention, the rotatable display device is a display or projector.

From another perspective, the invention is directed to a rotatable display device including a display unit, a storage unit, a rotation detecting unit, and a control module. The storage unit stores a plurality of display signal formats that is pre-defined, and each of the display signal formats corresponds to a display direction of the display unit respectively. The rotation detecting unit is configured for detecting the display direction of the display unit. The control module is coupled to the storage unit and the rotation detecting unit, so as to provide one of the display signal formats to a host according to the display direction of the display unit, such that the display unit displays an image signal outputted according to the display signal format received by the host.

In one embodiment of the invention, after the rotation detecting unit detects the display direction of the display unit, the control module selects the display signal format corresponding to the display direction from all of the display signal formats and provides the selected display signal format to the host.

In one embodiment of the invention, the control module controls the rotatable display device to disconnect and re-establish the connection with the host when the display direction is changed.

In one embodiment of the invention, the control module re-initiates the power of the rotatable display device when controlling the rotatable display device to disconnect and re-establish the connection with the host.

In one embodiment of the invention, each display signal format comprises a resolution and a scanning frequency of the corresponding display direction.

In one embodiment of the invention, each rotation detecting unit is a level, a supporting tenon of the rotatable display device, or a button, for example.

In one embodiment of the invention, the rotatable display device is a display or projector.

From another perspective, the invention is directed to a rotatable display device including a display unit, a storage unit, a rotation detecting unit, and a control module. A first display signal format and a second display signal format that are pre-defined are stored by the storage unit. The first display signal format corresponds to a horizontal direction and the second display signal format corresponds to a vertical direction. The rotation detecting unit is configured for detecting the display direction of the display unit. The control module is coupled to the storage unit and the rotation detecting unit. The control module provides the first display signal format or the second display signal format to a host according to the display direction of the display unit, so that the display unit displays an image signal outputted according to the first display signal format or the second display signal format received by the host.

In light of the foregoing, in the invention, the rotatable display device automatically detects the display direction thereof so as to dynamically select the display signal format to be provided to the host according to the display direction. Accordingly, the host is capable of outputting the image signal directly to the rotatable display device according to the display signal format received. The rotatable display device can thus display the image correctly, such that the manual adjustment of pre-determined settings by the user at the host end is no longer required after the display direction of the rotatable display device is changed. The utility convenience of the rotatable display device is thus greatly enhanced.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing a rotatable display device according to an embodiment of the invention.

FIG. 2 is a flow chart of an image displaying method according to an embodiment of the invention.

FIG. 3A is a block diagram showing a rotatable screen according to an embodiment of the invention.

FIGS. 3B and 3C are perspective diagrams illustrating configurations of the rotatable screen in the horizontal direction and the vertical direction respectively.

FIG. 4 is a flow chart of an image displaying method according to another embodiment of the invention.

### DESCRIPTION OF EMBODIMENTS

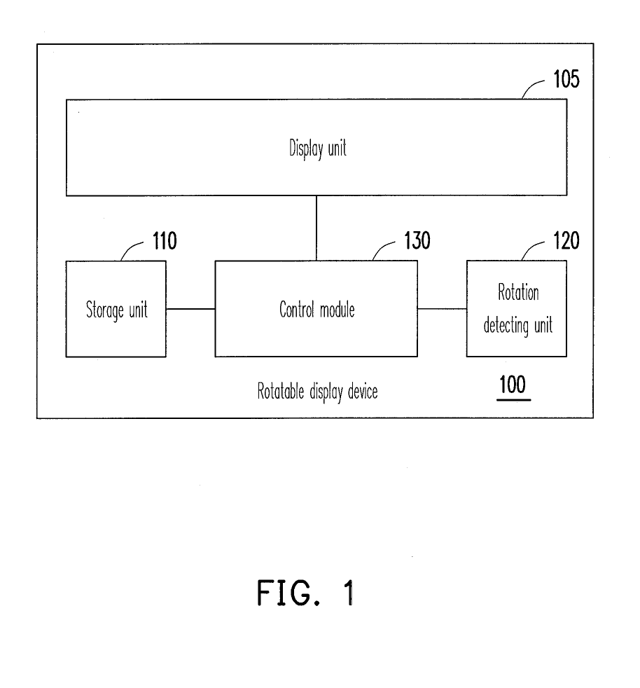

FIG. 1 is a block diagram showing a rotatable display device according to an embodiment of the invention. Referring to FIG. 1, a rotatable display device 100 includes a display unit 105, a storage unit 110, a rotation detecting unit 120, and a control module 130. In the present embodiment, the rotatable display device 100 is a display or projector, for instance, and can be connected to a host through various interface standards such as video graphics array (VGA) interface, digital visual interface (DVI), or DisplayPort interface. Here, the host is a computer host or a host of other electronic devices, and the invention is not limited thereto.

The display unit 105 is, for example, a liquid crystal display (LCD) and displays the image. The storage unit 110 is a programmable read only memory (PROM) or an electrically erasable programmable read only memory (EEPROM), for example, and stores a plurality of display signal formats which is pre-defined. Herein, each of the display signal formats corresponds to a display direction of the display unit 105 respectively. In the present embodiment, each display signal format comprises a resolution and a scanning frequency consistent with the corresponding display direction. For example, one of the display signal formats recorded in the storage unit 110 corresponds to the horizontal direction and includes a resolution of 1920×1080 and a scanning frequency of 60 Hz. Another display signal format recorded in the storage unit 110 corresponds to the vertical direction and includes a resolution of 1080×1920 and a scanning frequency of 60 Hz.

The rotation detecting unit 120 is a level (e.g. a spirit level), a supporting tenon of the rotatable display device 100, a button, or other sensors capable of responding to the rotation state of the device, and the invention is not limited herein. The rotation detecting unit 120 is configured for detecting the instant display direction of the display unit 105 in the rotatable display device 100.

The control module 130 is coupled to the display unit 105, the storage unit 110, and the rotation detecting unit 120. The control module 130 provides one of the display signal formats stored in the storage unit 110 to the host according to the display direction of the rotatable display device 100 (that is, the display direction of the display unit 105), so that the display unit 105 displays an image signal outputted according to the display signal format received by the host.

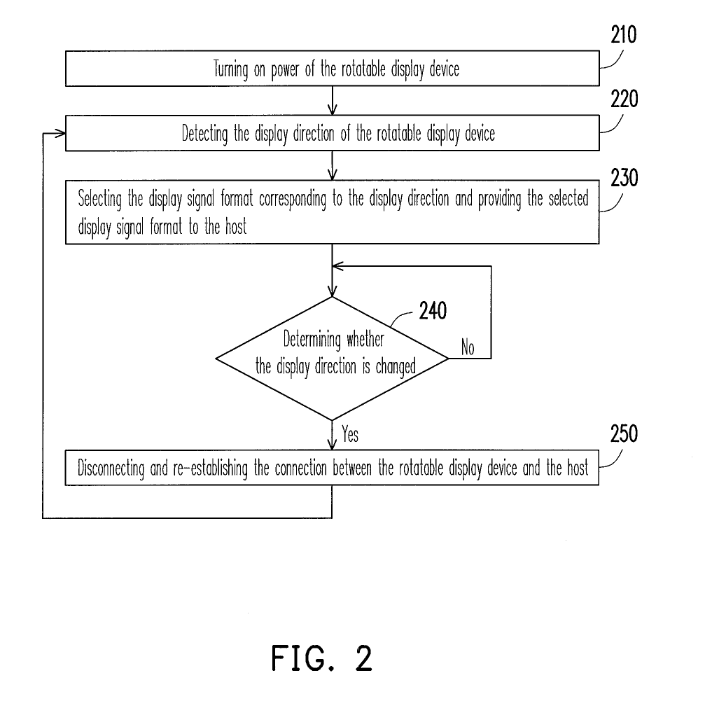

In order to further illustrate the operation flowchart of the rotatable display device 100, another embodiment is provided in the following. FIG. 2 is a flow chart of an image displaying method according to an embodiment of the invention. In the present embodiment, the storage unit 110 in the rotatable display device 100 stores a plurality of pre-defined display signal formats, where each display signal format corresponds to a display direction respectively.

Referring to FIG. 2, as shown in step 210, the power of the rotatable display device 110 which connected to a host is turned on. In step 220, the rotation detecting unit 120 detects the instant display direction of the rotatable display device 100.

As shown in step 230, the control module 130 selects the display signal format corresponding to the display direction of the rotatable display device 100 from all of the display signal formats stored in the storage unit 110, and provides the selected display signal format to the host. Accordingly, a display card within the host outputs the image signal directly according to the display signal format received. After the rotatable display device 100 receives the image signal, the display unit 105 can then display the image with correct angle.

The rotation detecting unit 120 can detect the instant display direction of the rotatable display device 100; thus, in order to respond the user's rotational operation timely, the control module 130 persistently determines whether the display direction has been changed, as shown in step 240. When the control module 130 determines the display direction detected by the rotation detecting unit 120 this time to be different from the display direction detected previously, the control module 130 controls the rotatable display device 100 to disconnect the connection with the host and then to re-establish the connection with the host in step 250. Specifically, the control module 130 first turns off the power of the rotatable display device 100 to disconnect the rotatable display device 100 and the host. The control module 130 then turns on the power of the rotatable display device 100 to re-establish the connection between the rotatable display device 100 and the host.

When the rotatable display device 100 has been restarted, the flow chart of this image displaying method returns to step 220, where the rotation detecting unit 120 detects the instant display direction of the rotatable display device 100. Then, in step 230, the control module 130 selects the suitable display signal format according to the instant display direction and provides the display signal format to the host. At this time, the display signal format adopted by the host when outputting the image signal is the instant display direction of the rotatable display device 100 (that is, the direction after the rotation).

The image displaying method of the present embodiment repeats steps 220˜250 in FIG. 2. Once the user rotates the rotatable display device 100 so as to change the display direction of the rotatable display device 100, the control module 130 provides the display signal format corresponding to the new display direction by re-initiating the power of the rotatable display device 100. In other words, after the rotatable display device 100 is rotated, the host is like being connected to a new display device having a different resolution. The host end no longer needs to adjust the image signal to be outputted and the rotatable display device 100 can display the image correctly.

In the foregoing embodiment, the connection between the rotatable display device 100 and the host is disconnected and then re-established by re-initiating the power. However, in other embodiments, the control module 130 can shut down the signal transmittance between the rotatable display device 100 and the host dynamically so as to disconnect the connection therebetween. The control module 130 then outputs the signal again to re-establish the connection between the rotatable display device 100 and the host.

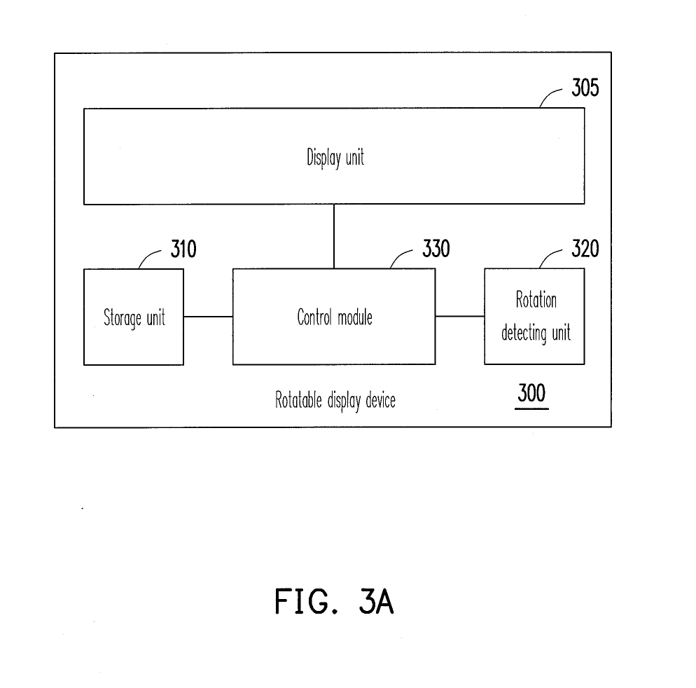

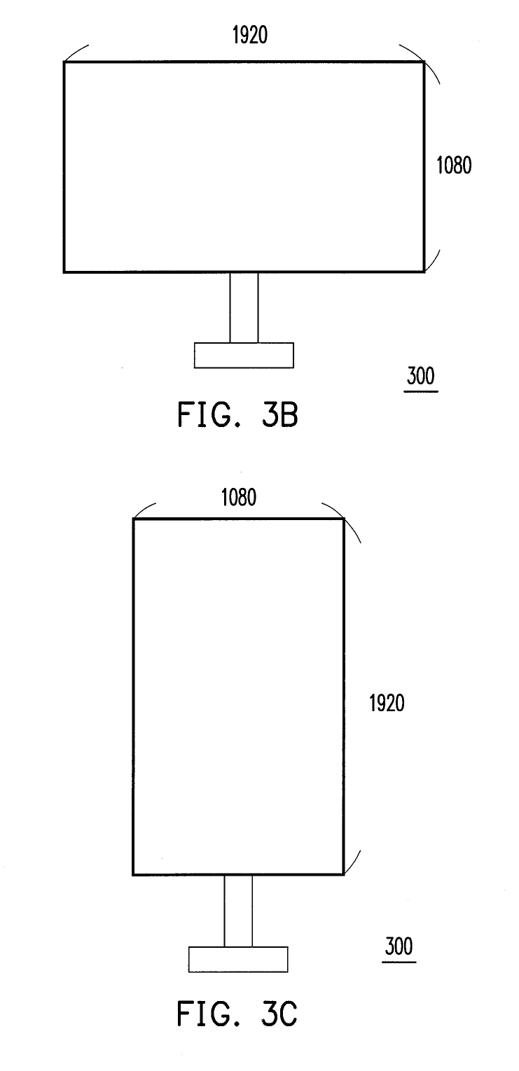

In the following, a rotatable display device having two display directions is used as an example to illustrate the invention. FIG. 3A is a block diagram showing a rotatable display device according to an embodiment of the invention. A rotatable display device 300 includes a display unit 305, a storage unit 310, a rotation detecting unit 320, and a control module 330. In the present embodiment, the rotatable display device 300 is a display or projector, and the rotation detecting unit 320 is a level, a supporting tenon of the rotatable display device 300, or a button, for example.

In the present embodiment, the user can rotate the rotatable display device 300 into the horizontal direction or the vertical direction. FIGS. 3B and 3C are perspective diagrams illustrating configurations of the rotatable display device 300 in the horizontal direction and the vertical direction respectively. In the present embodiment, it is assumed that when the image is displayed horizontally, the maximum resolution supported by the rotatable display device 300 is 1920×1080. On the other hand, when the image is displayed vertically, the maximum resolution supported by the rotatable display device 300 is 1080×1920.

The storage unit 310 records a first display signal format corresponding to the horizontal direction and a second display signal format corresponding to the vertical direction. The first display signal format includes a resolution of 1920×1080 and a scanning frequency of 60 Hz. The second display signal format includes a resolution of 1080×1920 and a scanning frequency of 60 Hz.

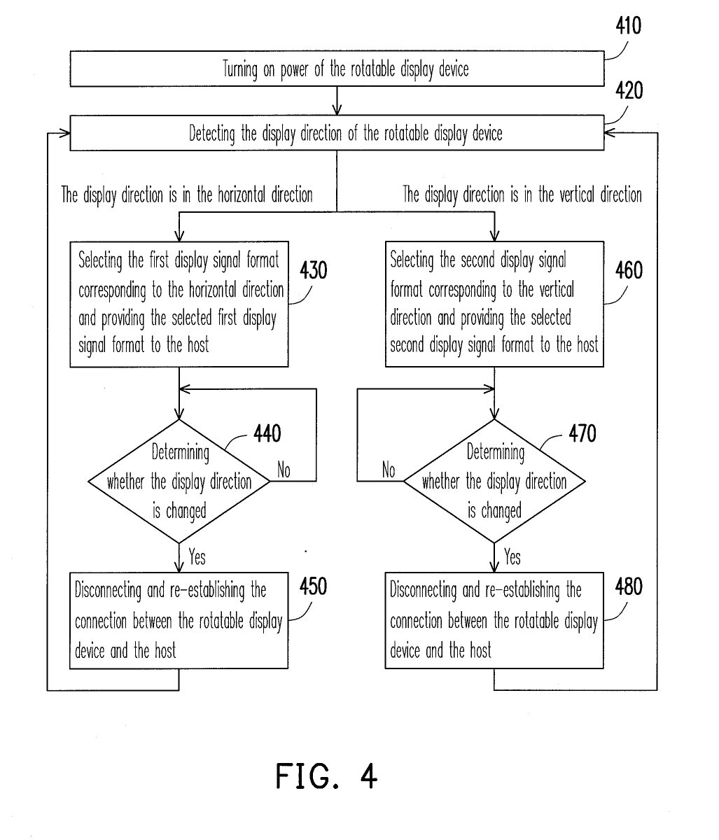

Next, the flow chart of the image displaying method shown in FIG. 4 is applied to describe the detailed operation of each component in the rotatable display device 300. As shown in step 410, the power of the rotatable display device 300 connected to the host is turned on. In step 420, the rotation detecting unit 320 detects the instant display direction of the rotatable display device 300.

It is assumed that the instant display direction of the rotatable display device 300 is as that shown in FIG. 3B (that is, the horizontal direction); then, as shown in step 430, the control module 330 selects the first display signal format corresponding to the horizontal direction from the first display signal format and the second display signal format recorded in the storage unit 310 and provides the first display signal format to the host. Therefore, after receiving the first display signal format, the host outputs the image signal according to the 1920×1080 resolution and the 60 Hz scanning frequency recorded in the first display signal format.

In step 440, the control module 330 determines whether the display direction of the rotatable display device 300 is changed by continuously monitoring information provided by the rotation detecting unit 320. Once the control module 330 determines the display direction of the rotatable display device 300 to be changed (that is, the horizontal direction shown in FIG. 3B is changed into the vertical direction shown in FIG. 3C), then the control module 330 disconnects and re-establishes the connection between the rotatable display device 300 and the host as shown in step 450. For example, the control module 330 re-initiates the power of the rotatable display device 300 to disconnect and then re-establish the connection between the rotatable display device 300 and the host.

Thereafter, the flow chart of this image displaying method returns to step 420, and the rotation detecting unit 320 detects the instant display direction of the rotatable display device 300. Since the rotatable display device 300 has been changed into the vertical direction as that shown in FIG. 3C before the rotatable display device 300 is re-connected to the host, the control module 300 selects the second display signal format corresponding to the vertical direction from the first and the second display signal formats and provides the second display signal format to the host. At this time, the host outputs the image signal according to the 1080×1920 resolution and the 60 Hz scanning frequency recorded in the second display signal format.

Similarly, the control module 330 then repetitively determines whether the display direction of the rotatable display device 300 is changed (step 470). When the display direction is changed again (that is, changed from the vertical direction shown in FIG. 3C into the horizontal direction shown in FIG. 3B), the control module 330 then disconnects and re-establishes the connection between the rotatable display device 330 and the host (step 480). Consequently, after the rotatable display device 300 is re-connected to the host, the rotation detecting unit 320 can detect the new display direction (step 420), such that the control module 330 can re-select and then transmit the first display signal format to the host (step 430).

By repeating the above steps, the suitable display signal format can be provided to the host dynamically according to the instant display direction of the rotatable display device 300 when using the rotatable display device 300. Accordingly, the host only needs to output the image signal according to the display signal format received for the display unit 305 to display the image with correct angle, and no additional signal processing is required.

In summary, in the rotatable display device and the image displaying method thereof in the invention, a plurality of display signal formats is disposed in the display device, so that the display device selects the suitable display signal format to be transmitted to the host according to the display direction after automatically detecting the instant display direction. Hence, the host end can output the image signal directly according to the display signal format received, such that the manual adjustment of relevant settings at the host end by the user after the display device has been rotated can be eliminated so as to enhance the convenience in use of the rotatable display device.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An image displaying method adopted in a rotatable display device, the method comprising:
defining a plurality of display signal formats, each of the display signal formats is corresponding to a display direction of the rotatable display device respectively;
providing one of the display signal formats to a host according to the display direction of the rotatable display device; and
displaying an image signal outputted according to the display signal format received by the host.

2. The image displaying method as claimed in claim 1, wherein the step of providing one of the display signal formats to the host according to the display direction of the rotatable display device comprises:
detecting the display direction of the rotatable display device;
selecting one of the display signal formats corresponding to the display direction from all of the display signal formats; and
providing the selected display signal format to the host.

3. The image displaying method as claimed in claim 1, wherein the step of providing one of the display signal formats to the host according to the display direction of the rotatable display device further comprises:
disconnecting and re-establishing the connection between the rotatable display device and the host when the display direction is changed.

4. The image displaying method as claimed in claim 3, wherein the step of disconnecting and re-establishing the connection between the rotatable display device and the host comprises:
re-initiating the power of the rotatable display device.

5. The image displaying method as claimed in claim 1, wherein each of the display signal formats comprises a resolution and a scanning frequency consistent with the corresponding display direction.

6. The image displaying method as claimed in claim 1, wherein the rotatable display device is a display or a projector.

7. A rotatable display device, comprising:
a display unit;
a storage unit for storing a plurality of pre-defined display signal formats, each of the display signal formats is corresponding to a display direction of the display unit respectively;
a rotation detecting unit for detecting the display direction of the display unit; and
a control module, coupled to the display unit, the storage unit, and the rotation detecting unit, wherein the control module provides one of the display signal formats to a host according to the display direction of the display unit for the display unit to display an image signal outputted according to the display signal format received by the host.

8. The rotatable display device as claimed in claim 7, wherein after the rotation detecting unit detects the display direction of the display unit, the control module selects one of the display signal formats corresponding to the display direction from all of the display signal formats and provides the selected display signal format to the host.

9. The rotatable display device as claimed in claim 7, wherein the control module controls the rotatable display device to disconnect and re-establish the connection with the host when the display direction is changed.

10. The rotatable display device as claimed in claim 7, wherein the control module re-initiates the power of the rotatable display device when controlling the rotatable display device to disconnect and re-establish the connection with the host.

11. The rotatable display device as claimed in claim 7, wherein each of the display signal formats comprises a resolution and a scanning frequency consistent with the corresponding display direction.

12. The rotatable display device as claimed in claim 7, wherein the rotation detecting unit comprises a level, a supporting tenon of the rotatable display device, and a button.

13. The rotatable display device as claimed in claim 7, wherein the rotatable display device is a display or a projector.

14. A rotatable display device, comprising:
a display unit;
a storage unit for storing a first display signal format and a second display signal format of which are pre-defined, wherein the first display signal format corresponds to a horizontal direction and the second display signal format corresponds to a vertical direction;
a rotation detecting unit for detecting a display direction of the display unit; and
a control module, coupled to the display unit, the storage unit, and the rotation detecting unit, the control module providing the first display signal format or the second display signal format to a host according to the display direction of the display unit for the display unit to display an image signal outputted according to the first display signal format or the second display signal format received by the host.
